(19) United States
(12) Patent Application Publication
(10) Pub. No.: US 2015/0109169 A1
(43) Pub. Date: Apr. 23, 2015

(54) WIRELESS COMMUNICATION DEVICE

(71) Applicant: FIH (Hong Kong) Limited, Kowloon (HK)

(72) Inventors: CHENG-HUNG KO, Shindian (TW); CHAO-WEI HO, New Taipei (TW)

(21) Appl. No.: 14/487,649

(22) Filed: Sep. 16, 2014

(30) Foreign Application Priority Data
Oct. 21, 2013 (TW) 102137853

(51) Int. Cl. H01Q 9/04

(52) U.S. Cl. CPC H01Q 9/0407
USPC 343/700 MS

(57) ABSTRACT

A wireless communication device includes a printed circuit board (PCB), a main antenna, and a coupling member. The main antenna is positioned on the PCB, and includes a first radiation portion and a second radiation portion. A first end of the coupling member is grounded via the PCB, and a second end of the coupling member is located between the first radiation portion and the second radiation portion. The coupling member is resonant with the first radiation portion and the second radiation portion.

### FIELD

The disclosure generally relates to a wireless communication device.

### BACKGROUND

Long term evolution (LTE) antennas are used in wireless communication devices such as mobile phones, for receiving and transmitting wireless signals at a plurality of bandwidths.

### BRIEF DESCRIPTION OF THE DRAWINGS

Many aspects of the present disclosure can be better understood with reference to the drawings. The components in the drawings are not necessarily drawn to scale, the emphasis instead being placed upon clearly illustrating the principles of the disclosure. Moreover, in the drawings, like reference numerals designate corresponding parts throughout the views.

FIG. 1 is an isometric view of a wireless communication device employing an antenna structure according to an exemplary embodiment.

FIG. 2 is a voltage standing wave ratio (VSWR) graph of the wireless communication device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to be essentially conforming to a particular dimension, shape, or other feature that is modified by the use of the term, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

The present disclosure is described in relation to a wireless communication device.

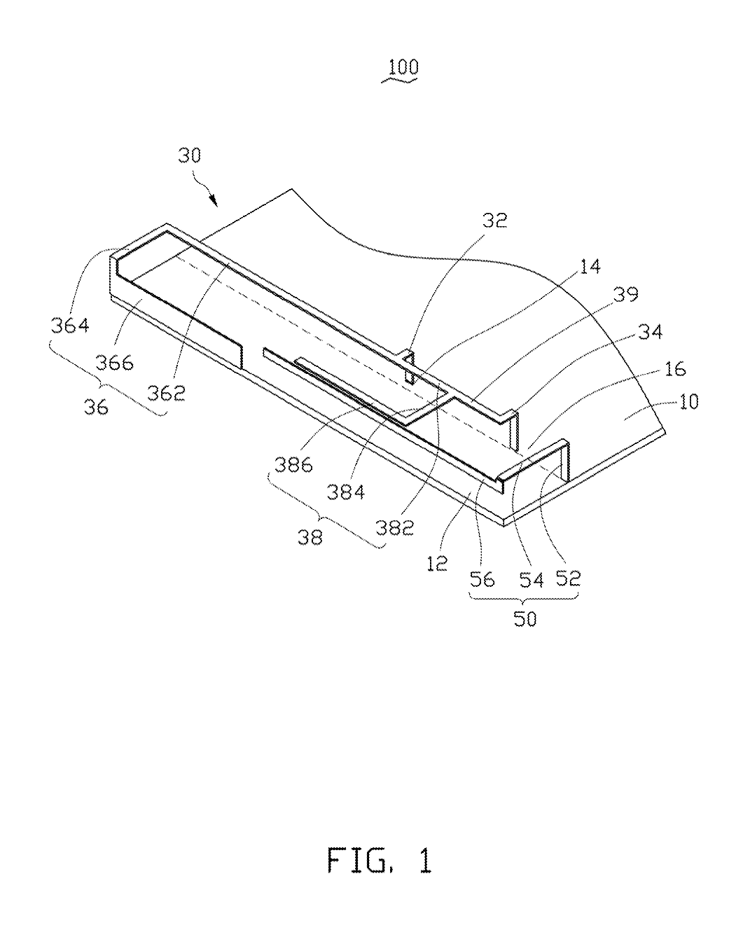

FIG. 1 illustrates a wireless communication device 100, according to an exemplary embodiment. The wireless communication device 100 can be a mobile phone or a tablet computer for example (neither are shown).

The wireless communication device 100 includes a printed circuit board (PCB) 10, a main antenna 30, and a coupling member 50. Both the main antenna 30 and the coupling member 50 are positioned on the PCB 10.

The PCB 10 is a substantially rectangular board having a keep-out-zone 12. The purpose of the keep-out-zone 12 is to delineate an area on the PCB 10 in which other elements (such as a camera, a vibrator, a speaker, etc.) cannot be placed.

In at least one embodiment, the keep-out-zone 12 is located near an end of the PCB 10. The PCB 10 further forms a feed pin 14 and a ground plane 16 adjacent to the keep-out-zone 12. The feed pin 14 provides current for the main antenna 30 and the coupling member 50, and the main antenna 30 and the coupling member 50 can be grounded by the ground plane 16.

The main antenna 30 can be any structure. In at least one embodiment, the main antenna 30 is a planar inverted-F (PIFA) structure, and includes a feed end 32, a ground end 34, a first radiation portion 36, a second radiation portion 38, and a connection portion 39.

The feed end 32 is substantially a reversed L-shaped sheet, and is substantially perpendicular to the PCB 10 to be coupled to the feed pin 14. The ground end 34 is substantially a reversed L-shaped sheet, and is substantially perpendicular to the PCB 10 to be coupled to the ground plane 16.

The first radiation portion 36 is located above the keep-out-zone 12, and includes a first connection section 362, a second connection section 364, and a third connection section 366. The first connection section 362 is perpendicularly connected to the feed end 32. The second connection section 364 is perpendicularly coupled between the first connection section 362 and the third connection section 366. The third connection section 366 is extended and opposite to the first connection section 362. In at least one embodiment, the third section 366 is a substantially rectangular sheet in order to sink a greater current.

The second radiation portion 38 is located above the keep-out-zone 12, and includes a first extending section 382, a second extending section 384, and a third extending section 386. The first extending section 382 extends linearly and continuously from the first connection section 362. The second extending section 384 is perpendicularly connected between the first extending section 382 and the third extending section 386. The third extending section 386 extends opposite to the first extending section 382. In at least one embodiment, a length of the second extending section 384 is less than a length of the second connection section 364, thus the third extending section 386 is located in between the first connection section 362 and the third connection section 366.

The connection portion 39 extends continuously from a junction between the first extending section 382 and a second extending section 384. An initial end of the connection portion 39 is linearly connected to the first extending section 382, and a distal end of the connection portion 39 is perpendicularly connected to the ground end 34.

The coupling member 50 is configured to adjust electromagnetic fields of the main antenna 30. The coupling member 50 is located above the keep-out-zone 12, and includes a first coupling section 52, a second coupling section 54, and a third coupling section 56. The first coupling section 52 is substantially perpendicular to the PCB 10 to couple to ground plane 16. The second coupling section 54 is perpendicularly connected between the first coupling section 52 and the third coupling section 56, and is parallel to the second connection section 364 and the second extending section 384. The third coupling section 56 extends towards the third connection section 366. In at least one embodiment, a length of the second coupling section 54 is greater than the length of the second extending section 384, but is less than the length of the second connection section 364, thus the third coupling section 56 is in between the third extending section 386 and the third connection section 366. Electric current on the third extending section 386 and the third connection section 366 can be coupled to the third coupling section 56 by adjusting spaces between the third coupling section 56 and the extending section 386 or between the third coupling section 56 and the third connection section 366.

When current is input to the main antenna 30 from the feed pin 14, a first portion of the current flows to the first radiation portion 36, and is coupled from the third connection section 366 to the third coupling section 56. A second portion of the current flows to the second radiation portion 38, and is coupled from the third extending section 386 to the third coupling section 56. Thus, the coupling member 50 and the first radiation portion 36 are resonant at a first bandwidth, which can be for example about 791˜960 MHZ. Additionally, the coupling member 50 and the second radiation portion 38 are resonant at a second bandwidth, which can be for example about 1710˜2690 MHZ.

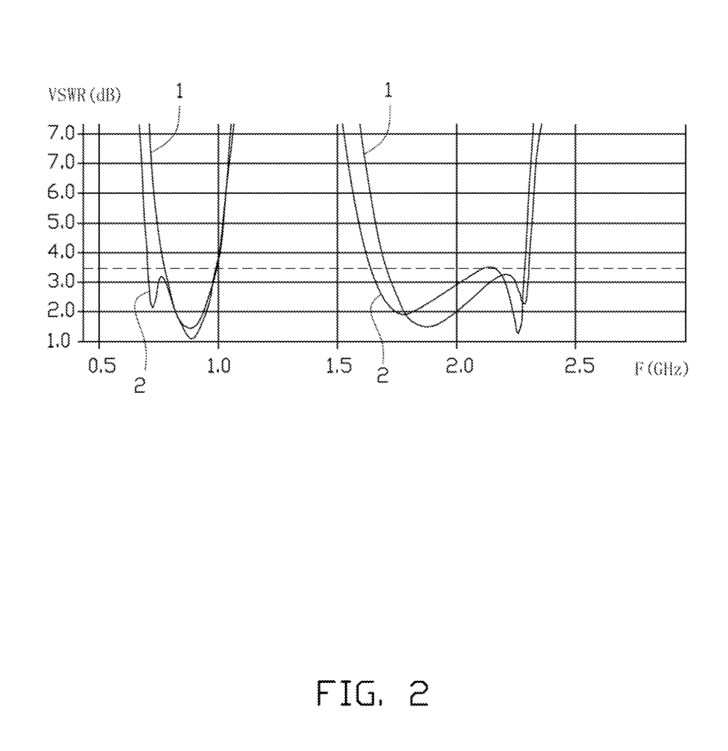

FIG. 2 illustrates a voltage standing wave ratio (VSWR) graph of the wireless communication device 100. A curve 1 indicates a low bandwidth and a high bandwidth when the wireless communication device 100 does not employ the coupling member 50. A curve 2 indicates a low bandwidth and a high bandwidth when the wireless communication device 100 employs the coupling member 50. Comparing curve 1 with curve 2, the low bandwidth and the high bandwidth of the curve 2 are broader, and the main antenna 30 can resonate at a new bandwidth adjacent to the low bandwidth of the curve 2.

As stated in Table 1 in this paragraph, a relationship between a frequency and a gain of the wireless communication device 100 is shown. The wireless communication device 100 has good performance when operating at Band17, Band20, GSM850, EGSM900, DCS1800, PCS1900, Band1, Band7.

TABLE 1

| | Frequency (MHz) | | | | | | | | |
|---|---|---|---|---|---|---|---|---|---|
| | 791 | 824 | 890 | 960 | 1710 | 1880 | 2170 | 2500 | 2690 |
| Gain | −1.91 | −1.52 | −0.56 | −2.28 | −2.59 | −1.79 | −4.3 | −3.38 | −3.25 |
| (dB) | | | | | | | | | |

In summary, the coupling member 50 is resonant with the first radiation portion 36 and the second radiation portion 38 to increases the bandwidths of the wireless communication device 100. Thus, the wireless communication device 100 can receive wireless signals at an LTE band, which can be for example about 791˜862 MHz. Additionally, the wireless communication device 100 does not need any additional antennas, effectively freeing space in the wireless communication device 100.

It is to be understood, however, that even through numerous characteristics and advantages of the present disclosure have been set forth in the foregoing description, together with details of assembly and function, the disclosure is illustrative only, and changes may be made in detail, including in the matters of shape, size, and arrangement of parts within the principles of the disclosure to the full extent indicated by the broad general meaning of the terms in which the appended claims are expressed.

What is claimed is:

1. A wireless communication device, comprising:
a printed circuit board (PCB);
a main antenna coupled to the PCB and comprising a first radiation portion and a second radiation portion; and
a coupling member having a first end and a second end, wherein the first end is coupled to the PCB and ground and the second end is located between the first radiation portion and the second radiation portion;
wherein the coupling member is resonant with the first radiation portion or the second radiation portion.

2. The wireless communication device as claimed in claim 1, wherein the PCB forms a feed pin and a ground plane, the main antenna comprises a feed end and a ground end, the feed end is coupled to the feed pin, and the ground end is coupled to the ground plane.

3. The wireless communication device as claimed in claim 2, wherein both the first radiation portion and the second radiation portion are connected to the feed end and are grounded via the ground end.

4. The wireless communication device as claimed in claim 3, wherein the first radiation portion comprises a first connection section, a second connection section, and a third connection section; the first connection section is connected to the feed end; the second connection section is coupled between the first connection section and the third connection section; and the third connection section extends opposite to the first connection section.

5. The wireless communication device as claimed in claim 4, wherein the second radiation portion comprises a first extending section, a second extending section, and a third extending section, the first extending section extends lineally and continuously from the first connection section, the second extending section is connected between the first extending section and the third extending section. the third extending section extends opposite to the first extending section.

6. The wireless communication device as claimed in claim 5, wherein the third extending section is in between the first connection section and the second connection section.

7. The wireless communication device as claimed in claim 5, further comprising a connection portion extending continuously from a junction of the first extending section and a second extending section, wherein an initial end of the connection portion is lineally connected to the first extending section, and a distal end of the connection portion is connected to the ground end.

8. The wireless communication device as claimed in claim 7, wherein the coupling member comprises a first coupling section, a second coupling section, and a third coupling section; the first coupling section is perpendicular to the PCB and configured to couple to a ground plane; the second coupling section is connected between the first coupling section and the third coupling section, and is parallel to the second connection section and the second extending section; and the third coupling section extends towards the second connection section.

9. The wireless communication device as claimed in claim 8, wherein the third coupling section is in between the third extending section and the second connection section.

10. A wireless communication device, comprising:
a printed circuit board (PCB);
a main antenna positioned on the PCB, the main antenna comprising a first radiation portion and a second radiation portion; and
a coupling member; a first end of the coupling member grounded via the PCB, and a second end of the coupling member located between the first radiation portion and the second radiation portion;
wherein the coupling member is coupled to the first radiation portion to receive/transmit wireless signals at a first bandwidth, and the coupling member is coupled to the second radiation portion to receive/transmit wireless signals at a second bandwidth.

11. The wireless communication device as claimed in claim 10, wherein the PCB forms a feed pin and a ground plane; the main antenna comprises a feed end and a ground end; the feed end is coupled to the feed pin; and the ground end is coupled to the ground plane.

12. The wireless communication device as claimed in claim 11, wherein the first radiation portion comprises a first connection section, a second connection section, and a second connection section, the first connection section is connected to the feed end, the second connection section is coupled between the first connection section and the third connection section, and the third connection section extends opposite to the first connection section.

13. The wireless communication device as claimed in claim 12, wherein the second radiation portion comprises a first extending section, a second extending section, and a third extending section, the first extending section extends lineally and continuously from the first connection section, the second extending section is connected between the first extending section and the third extending section. the third extending section extends opposite to the first extending section, and is in between the first connection section and the second connection section.

14. The wireless communication device as claimed in claim 13, further comprising a connection portion extending continuously from a junction of the first extending section and a second extending section, wherein an initial end of the connection portion is lineally connected to the first extending section, and a distal end of the connection portion is connected to the ground end.

15. The wireless communication device as claimed in claim 14, wherein the coupling member comprises a first coupling section, a second coupling section, and a third coupling section, the first coupling section is perpendicular to the PCB to couple to ground plane, the second coupling section is connected between the first coupling section and the third coupling section, and is parallel to the second connection section and the second extending section, the third coupling section extends towards the second connection section, and is in between the third extending section and the second connection section.
